(19) United States
(12) Patent Application Publication
(10) Pub. No.: US 2012/0005024 A1
(43) Pub. Date: Jan. 5, 2012

(54) METHODS FOR SELECTING AND DISPLAYING ADVERTISING LINKS

(75) Inventor: Álvaro Fernández Gutiérrez, Barcelona (ES)

(73) Assignee: MEDIA PATENTS, S.L., Barcelona (ES)

(21) Appl. No.: 13/192,353

(22) Filed: Jul. 27, 2011

Related U.S. Application Data
(63) Continuation of application No. PCT/ES10/70057, filed on Feb. 3, 2010.

(30) Foreign Application Priority Data
Feb. 13, 2009 (ES) P200900409

(51) Int. Cl. G06Q 30/00

(52) U.S. Cl. 705/14.58

(57) ABSTRACT

A method for selecting one or more advertising links for incorporation into a web page of an affiliate website stored on an affiliate web server when the affiliate web server receives a request message from a browser of a computing device that requests the web page. In one implementation a control application running on an affiliate webserver facilitates the reception of the one or more advertising links and first information related to the one or more advertising links from one or more intermediary servers, the first information received from each of the one or more intermediary servers includes target geographic data for each of the advertising links and compensation information of each of the one or more intermediary servers payable to the content website upon the one or more advertising links being activated by the computing device. In one implementation the control application stores the one or more advertising links and the first information in a database and determines the geographic location of the computing device. In one implementation the control application then selects from among the one or more advertising links stored in the database one or more of the advertising links to be displayed on the web page, the one or more selected advertising links to be displayed on the web page being selected by a comparison of the target geographic data of the advertising links with the geographic location of the computing device and a comparison of the compensation information associated with each of the one or more advertising links. In one implementation, upon the control application inserting the selected one or more links into the web page it causes the web server to transmit to the browser of the computing device the web page together with the selected one or more links.

### CROSS-REFERENCE TO RELATED APPLICATIONS

This application relates to and claims priority to International Application PCT/ES2010/070057, filed Feb. 3, 2010, which relates to and claims priority to Spanish Patent Application No. P200900409, filed Feb. 13, 2009.

### TECHNICAL FIELD

The methods relate to the field of Internet advertising.

### BACKGROUND

Companies selling products or services that advertise on the Internet try to ensure that their website can be found as easily as possible by users surfing the network who may be interested in their products or services.

Advertising on search engines is a commonly used method for attracting possible buyers to a website. This system has the advantage of enabling the advertiser to segment the advertising, such that the advertiser is able to select keywords whose search will show results where the advertisements appear.

When a user conducts a search using an Internet search engine and inputs text for the search that includes a keyword selected by one or several advertisers, the search engine displays the addresses of those advertisers. These systems provide advertisers with tools to help them manage their campaigns. For example, the AdWords system which is part of Google's search engine allows advertisers to choose the price they want to pay each time a user clicks on its advertisements in relation to the chosen keyword, and displays information to them about the number of times that each advertisement is displayed, the number of clicks, and the percentage, called “CTR” or “ClickThrough,” which is the number of times that users click on an advertisement, divided by the number of times that the advertisement has been displayed. In the customary online terminology, the number of times that an advertisement is displayed on a screen usually called the “number of impressions,” although this number has no relationship to whether or not the user prints the advertisement.

AdWords also reports the average position in which each advertisement appears. This data is relevant because users tend to click more frequently on advertisements appearing in the first positions.

Another well-known method for attracting online visitors consists of advertising the products on a website using content that attract users interested in a specific term. Such content websites may be, for example, thematic pages on video games, movies, music, computer programs, etc. The addresses are available as a link pointing to the selling company's website, such that when the user clicks on one of these links he is redirected to that particular website of the selling company, and the latter remunerates the content websites in relation to the number of clicks made on the links. For this method to be effective, the selling companies must be connected with the content websites and the way in which link-advertisements are incorporated, and the manner in which they are remunerated for the clicks made, has to be organised technically.

One existing system that solves this requirement is the Google “AdSense” system, described in U.S. patent applications published as US2004/0093327 and US2004/0059708, and in U.S. Pat. No. 5,948,061. This system enables a website to include advertising from several advertisers and to receive remuneration for it. The advertisers using this system can advertise on web pages belonging to the “search engine network” or those belonging to the “content network” of the Google search engine. The “search engine network” comprises Web pages where the Google search dialog box appears, in which a search can be conducted in the same way as on the Google search engine web page. When the search is conducted, normal or “basic” results, and also advertisements in the form of “sponsored links” appear. The “content network” comprises websites displaying advertisements for advertisers whose products are related to the content. The “AdSense” system analyses the content of websites that seek to host advertisements and decides which are the most appropriate for each advertisement. The advertisements contain a link to the advertiser's web page. Each time that a user clicks one of these linked ads, the web page owner hosting the ad receives remuneration from the advertiser.

FIG. 1, which is extracted from U.S. Pat. No. 5,948,061, shows an example of prior state-of-the-art content networks.

A browser 16 accesses a web page from the affiliated website 12 using the HTTP protocol. To do so, the browser sends an HTTP request message 20 to the affiliate website 12 and receives one or several HTTP reply messages 22 with the content of the requested web page.

When browser 16 uploads the web page from the affiliate website 12, the advertising server 19 inserts an advertisement into the web page. This can be accomplished for example, using an HTML language <img> tag that inserts images stored on another Web server into the web page. The browser sends a request message 23 to the server 19 to request the image indicated in the <img> tag and the server transmits the image by means of reply 24.

When the user of browser 16 acts on the image link containing an advertisement, browser 16 reconnects with advertising server 19 that than transmits the URL information for an advertiser's website 18. Next the browser requests the web page from the advertising site by means of an HTTP message 26, and the advertiser's website site transmits this web page by means of reply 28.

The affiliate website owner 12 receives compensation each time an advertisement is displayed or every time that an advertisement is activated from the user's browser. By means of the system described in U.S. Pat. No. 5,948,061, the owner of a website with content 12 that receives numerous visits can profit from the visits to its website by means of an agreement with the advertising server 19.

In general, the objective of the algorithms of AdSense-type systems managing advertising campaigns, is to maximise search engine income, which creates a problem for the owners of content websites, which do not have the negotiating capability of large Internet companies, such as for example Internet search engines, and consequently they likely receive a less than desired remuneration for each ad that they display on their web page, or for each advertisement that is activated on their web page.

In these systems the advertiser placing the advertisement does not know the price that the intermediary is paying the website where the content is inserted and, likewise, the content website does not know how much the advertiser is paying the intermediary for each click or every time that the advertisement appears. Thus, for example, the case could occur where the advertiser pays $1 for each click and the owner of the content website only receives $0.01 for each click.

An alternative system for profiting from content websites is a sales commission based system. In this system, websites known as affiliated or associated sites, collect a commission on the sales generated by their clicks. U.S. Pat. No. 5,991,740 and U.S. Pat. No. 6,029,141 describe systems of this type. In these systems the affiliated site charges a commission for the sales generated by each click on a link that directs the user from the web page of the affiliated site to a virtual store where the purchase is made.

FIG. 2 shows this type of commission based system. Specifically, it shows an online advertising system in which a device 252 uses a communication 201 to communicate with an advertising site 220 by means of the HTTP (Hypertext Transfer Protocol) protocol. Normally, to do this the HTTP protocol uses several TCP/IP connections over the Internet that are not shown in FIG. 2 for purposes of simplification. Device 252 can be a computer, a PDA, a mobile phone with a Web browser or any other device enabling the use of an Internet browser.

Likewise, line 202 represents the communication that occurs using the HTTP protocol between computer 252 and an intermediary system 280.

Communication 203 displays the communication by means of the http protocol between computer 252 and a selling website 232.

A website is composed of a number of devices connected to the Internet, including a webpage server. Intermediary system 280 also consists of a set of devices connected to the Internet and can also contain a web page server.

Content website 220 contains a web page 223 with two advertisements or links 221 and 222. When browser 251 accesses this web page 223 and one of the links 221 or 222 is activated, the browser uses the HTTP protocol to access the web page for the URL associated with the link and to display the new web page. In this way the user can browse between different web pages by clicking on different links, each of which has an associated URL.

Link 222 has an associated URL that points to a web page for a virtual store 231 belonging to selling website 232 where the user using computer 252 can make an online purchase.

In the current state-of-the-art, website 232 can detect, by means of various systems, which website 220 is the one that directed the user to the virtual store, and can follow-up the user's transaction using transactional web 232 to remunerate the related website 220.

Various current state-of-the-art systems used for transmitting to the selling website 232, an information 229 that identifies advertising website 220 which generated the visit, are explained below.

As no direct TCP/IP connection is established between content website 220 and selling website 232, an indirect mechanism is needed to send information 229, identifying website 220 to website 232. The various current state-of-the-art systems or mechanisms utilise different http protocol properties to transmit this information 229 to website 232.

One method serves to transmit information 229 as a parameter of the link 222 URL that directs the user of website 220 to website 232. URL 204, which contains information 229, is sent from website 220 to browser 251 of computer 252 and browser 251 transmits the URL 204 together with information 229 to website 232 using the HTTP protocol to access website 232. Optionally, information 229 can also identify, which is the advertisement or link on which the user has clicked. In this way, if a user clicks on the advertisement for a certain product, website 232 receives information identifying the product and can directly display information about the product to the user when he accesses its website, thereby obviating the need for the user to browse the selling website 232 to locate the information. Examples of such processes are disclosed in U.S. Pat. No. 6,029,141.

Another method involves the use of an intermediary system 280 that serves as an intermediary between advertising website 220 and selling website 232. When the user clicks on link 221 he is directed to intermediary website 280, and from there redirected to selling website 232. Before redirecting the user, the intermediary system stores information 229 in a cookie 205 and sends cookie 205 to the user's computer. Virtual store 231 contains a final web page which the user accesses when he completes the online purchase or transaction. This web page includes a link to element 289 provided by the web server of intermediary site 280. This element can be, for example, an image, text or even an invisible image. When the user's browser 251 uses the HTTP protocol to read the final page, it has to access the intermediary site by means of http protocol to obtain element 289, and at that time cookie 205 is sent with information 229 to the intermediary site web server. An example of such a process is disclosed in U.S. Pat. No. 5,991,740.

### SUMMARY OF THE DISCLOSURE

According to one implementation a process is provided for selecting and displaying advertising links (3431, 3432) on a web page (342) of a content website (341) stored on a web server (340) when a browser (310) of a device (320) requests this web page using the HTTP protocol, the process comprising:
one or more intermediary servers of content networks (301, 302, 303) receive first information about advertising links from advertising websites (350), and;
the servers (301, 302, 303) transmit second information about advertising links to a control application (345) that is run on web server (340), and;
the web server (340) stores the information about the advertising links received from the intermediary servers of content networks (301, 302, 303) in database (344), and;
the information stored in the database (344) includes, at least, for each advertising link, a first data about the associated target geographic area and a second data about remuneration prices, and;
the control application (345) on the said web server (340) determines the originating IP address for the IP packets transporting the HTTP messages sent by browser (310) to request web page (342), and;
the control application (345) determines the geographic area where the device (320) is located from the originating IP address, and;
the control application (345) selects from this database (344), the advertising links, the first data associated with the geographic area which fully or partially coincides with the geographic area where the device (320) is located, and the second data which determines the compensation for the content website (341), and;
the control application (345) inserts advertising links (3431, 3432), into the said web page (342), and;
the web server (340) transmits to browser (310) of the device (320), the web page (342) together with the advertising links (3431, 3432) inserted into the web page, and;
the web page (342) with the advertising links inserted (3431, 3432) is displayed in the browser (310) of the device (320).

In one implementation database (344) is hosted on the same web server (340).

In another implementation database (344) is hosted on a different server to web server (340).

Preferably, when advertising link (3431, 3432) is activated in browser (310), device (320) sends an HTTP message (313) to an advertising website (350) to request a web page from the advertising site (350).

In one implementation the control application (345) inserts into web page (342) a code received from a content network intermediary server (404) that does not transmit any information to the control application (345).

In one implementation, when web server (340) receives the request for web page (342) from the browser, the control application (345) connects with the various content network intermediary servers (301, 302, 303) and updates database (344) with information about the advertising links corresponding to the geographic area where device (320) is located, before selecting the advertising links that will be inserted into web page (342).

In one implementation, the advertiser's website (350) is essentially a virtual store possessing a communications application for interchanging information with control application (345) and with the different content network intermediary servers.

In one implementation, the various content network intermediary servers (301, 302, and 303) communicate with one another and interchange advertising link information.

### BRIEF DESCRIPTION OF THE DRAWINGS

Additional advantages and characteristics of the invention can be seen from the following description that includes some non-limiting implementations, with reference to the attached drawings.

FIG. 1 illustrates an example of a prior art content network.

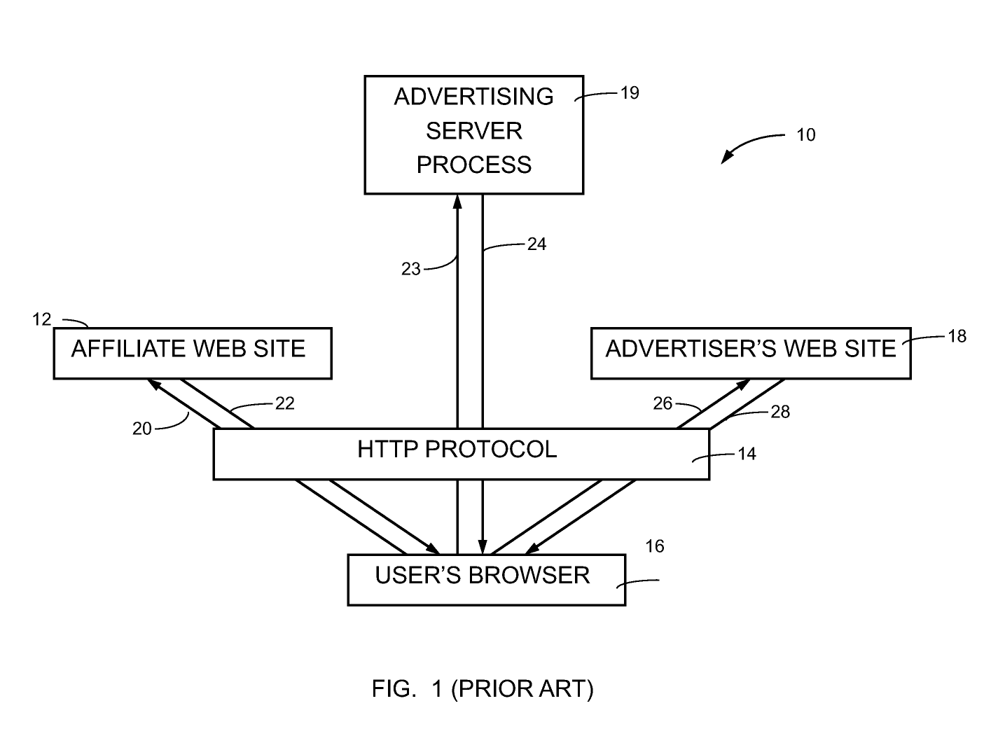

FIG. 2 shows an example of a prior art affiliates network.

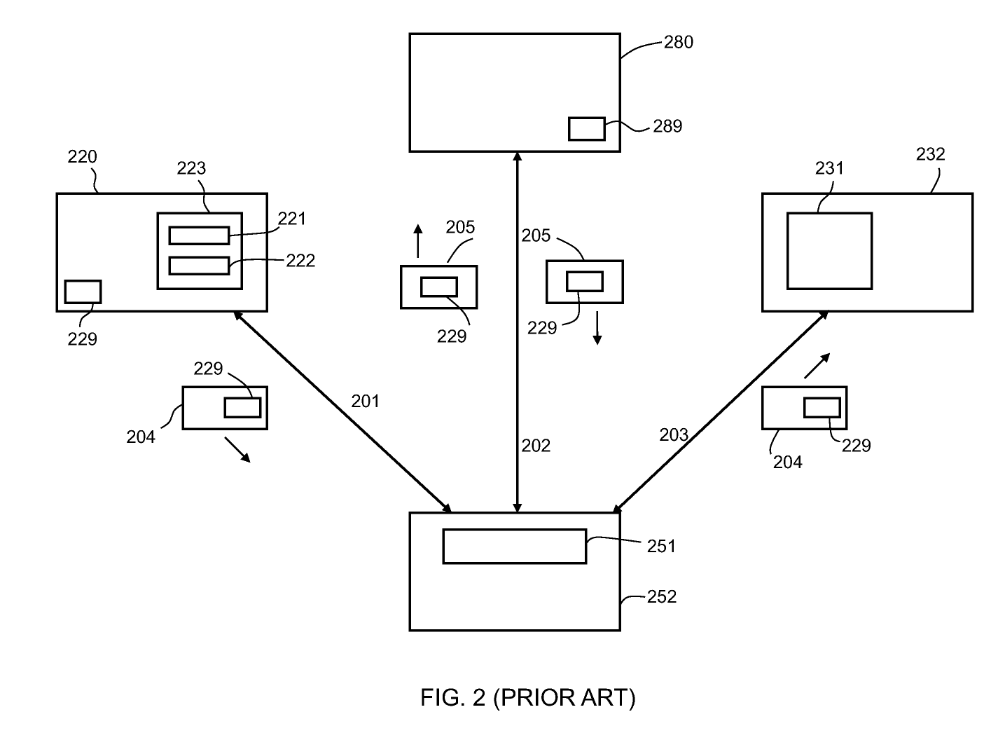

FIG. 3 illustrates an implementation of the present invention.

FIG. 4 illustrates another implementation of the present invention.

FIG. 5 is a flow chart of an advertising link selection method according to one implementation.

FIG. 6 illustrates another implementation of the present invention.

### DETAILED DESCRIPTION

One problem with current state-of-the-art content networks and affiliated networks is that they are designed so that a single intermediary site controls the prices paid by the advertisers, and the prices received by the content websites and the affiliated websites.

Hereinafter the terms “content website” and “affiliated website” are used interchangeably to refer to websites that charge for incorporating advertising links in their web pages, regardless of whether they receive a remuneration every time an advertisement is displayed on their web page, every time that an advertisement is activated on their web page, or every time that an action is performed after activating a link on their web page, such as for example, a purchase from a virtual store vested after activating the link.

The terms “advertisement” and “advertising link” are also used interchangeably to refer to advertisements that are added as links to the web page of the content website or affiliated website.

The current use of only one intermediary site results in no direct communications being established between the different sites involved in displaying an advertisement or following-up an online purchase. This hinders the interchange of data between the different websites participating in a content network displaying advertisements, or an affiliated network paying commissions.

Instead of communicating directly, the various prior state-of-the-art websites communicate through the user's browser, utilising various http protocol characteristics enabling the transmission of data from one website to another, such as for example cookies, or by adding data to the end of an URL, as explained previously.

These systems based on transmitting information through the browser have numerous limitations. For example, the process disclosed in U.S. Pat. No. 6,991,740 would not function with more than one intermediary site, as it would be necessary to add an element from each of the possible intermediary sites to the web page where the virtual store's transaction ended, so that the browser could send the cookie to the corresponding intermediary site. This solution is not practical and not viable if there are numerous intermediary sites.

Partly due to these limitations on the interchange of data through a browser, current state-of-the-art content networks are designed such that a single intermediary controls the entire technical process. It is the intermediary that selects each advertisement each time, and which selects the price paid for every advertisement to every content website, or what commission percentage is paid to the affiliated sites that charge commissions on sales made by associated virtual stores.

For example, in the Google AdSense content network advertisers are registered as advertisers by means of a Google web page and can choose keywords associated with their advertisements and the price to be paid by the advertiser for each click on its advertisement, or alternatively, the price to be paid every time its advertisement is displayed.

Google selects content websites in relation to the keywords, analysing the content of many content websites and establishing a correlation between the keywords chosen by the advertiser and the content of the analysed websites. Optionally, the advertiser can also choose the content websites where he wants to advertise.

The content website is also registered with Google AdSense and receives a code, for example, using the JavaScript programming language. Each time a user uploads a page from the content website containing this code the code is executed enabling Google to choose and insert into the web page the ads that are displayed in the user's browser. The owner of the content website may not be aware of the advertisements that are being displayed in the browser together with the content of his own website. Ultimately, the owner of the content website is remunerated for the advertising links displayed and/or activated. Nevertheless, neither the advertiser nor the owner of the content website is aware of the other party's prices. The content website owner does not know how much the advertiser pays for every click (e.g., 20 cents), and the advertiser does not know how much the content website owner charges for each click (e.g., 1 cent). As a result, the intermediary is in a position to choose the commercial margin he wishes to apply.

This invention solves this problem, by introducing competition and transparency for content networks, enabling the content website to choose the advertising links that are displayed on their websites.

Because there is no single intermediary site, but instead there are multiple intermediary sites, the control application at each content website communicates with servers belonging to the various intermediary sites to select the advertisements that are the most appropriate and/or beneficial to the content website itself.

Hereinafter the designation “content network intermediary servers” refers to the various intermediary site servers.

Another characteristic of this invention is that advertisers have multiple intermediaries available for contracting advertising. This benefits the advertisers by generating competition among the various intermediaries.

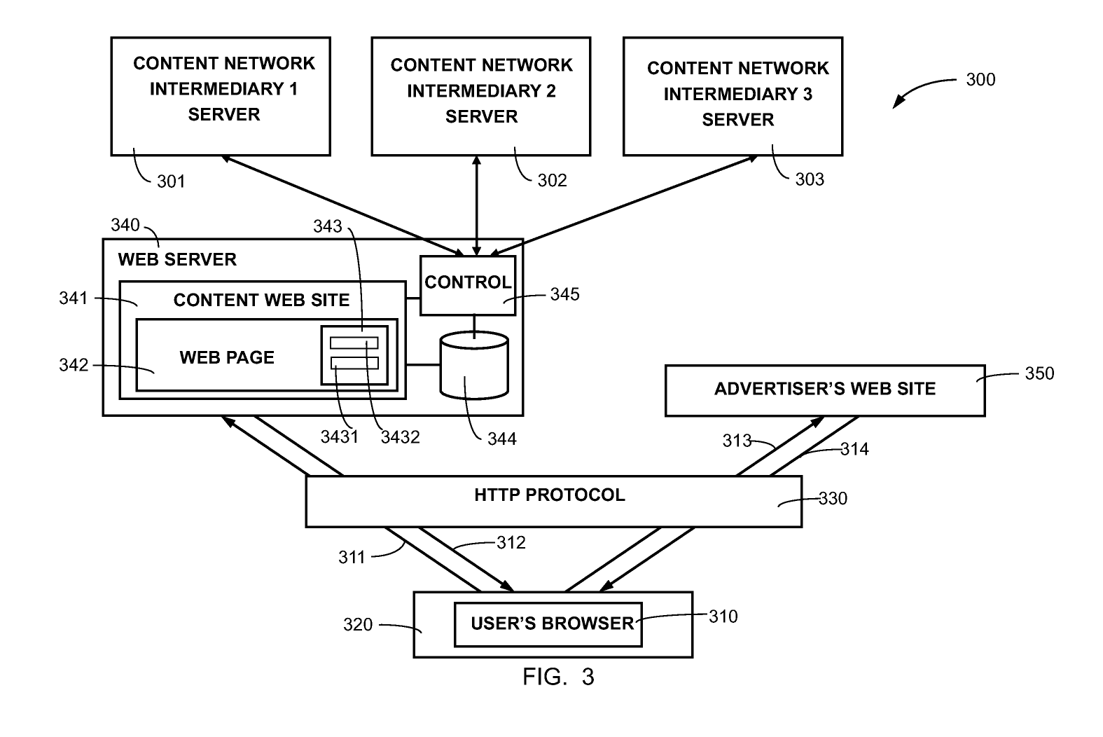

In the implementation of FIG. 3, a data network 300 may be observed, such as for example the Internet, where various devices communicate between each other.

On the data network 300, a user of an Internet navigator or browser 310 of a device 320 uses the HTTP protocol to access a web page 342 containing links 3431 and 3432.

The web page 342 is located at a content website 341 that is hosted on a web server 340.

When browser 310 seeks to access web page 342, it sends an HTTP request message 311 to web server 340 and the web server responds with one or several HTTP messages 312 that transmit the information from web page 342 together with information about links 3431 and 3432, so the information can be displayed on browser 310 of device 320.

Links 3431 and 3432 are http URI (http protocol Uniform Resource Identifiers) type links, which load specific web pages from advertising sites into the browser upon being activated by the user's browser. FIG. 3 shows only links 3431 and 3432 and a single advertising site 350. It is appreciated, however, that there may be a variable number of such links and a multitude of advertising sites.

When link 3431 is activated from browser 310, a web page from advertising site 350 is loaded into browser 310. There are several ways that the pages of the advertising website 350 can be loaded into the browser when link 3431 is activated.

One way is where link 3431 directly contains the URI for the destination web page of the advertising website.

Another way is for the URI contained within link 3431 directs the browser to an intermediate web page and that intermediate web page directs the browser to the destination web page on the advertiser's website. The http protocol redirection method can be used for this purpose.

Another way is to have the URI of link 3431 point to some JavaScript code stored, for example, on an intermediary server or on web server 340 itself, such that when link 3431 is activated, the JavaScript code is executed in the user's browser and this code, upon execution, causes the target web page from the advertising site to be loaded.

Although three examples have been described, other means for loading the destination web page of the advertising site upon activating link 3431 are possible.

When the browser accesses the target web page of the advertising site, the browser sends an HTTP request message 313 to advertising website 350 and the message 313 includes information about the URI of the target web page. Web server 350 receives message 313 and responds, sending one or several HTTP reply messages 314 containing the destination web page information advertised in link 3431.

Content website 341 can be composed of static web pages, for example pages coded directly into the HTML or XHTML languages or composed of dynamic web pages that generate the HTML or XHTML code in website 341 itself, for example generated using languages such as ASP (Active Server Pages), ASP.NET (Version for Visual Studio NET of ASP) or PHP.

The content website can also combine static pages and dynamic pages, and the same web page can also combine a static section and a dynamic section generated by the server itself.

Web server 340 executes a control application 345 that has a number of functions. One function is to manage communications with a multitude of content network intermediary servers 301, 302 and 303. Another function is to store information in database 344 and retrieve this stored information. Another function is to select links 3431 and 3432 whenever a web page 342 is requested, and to dynamically generate section 343 of web page 342 containing the links 3431 and 3432, using for such purpose for example, the previously mentioned ASP.NET or PHP technologies.

Content network intermediary servers 301, 302 and 303 act as intermediaries between the content websites, such as for example content website 340, and the various advertising websites that are interested in placing links 3431 and 3432 on web pages 342 of the content website pointing to the advertising websites.

For greater clarity, FIG. 3 shows a single website 340 with a single content website 341, a single advertising website 350, and three content network intermediary servers 301, 302 and 303. However, network 300 can consist of a multitude of content websites, a multitude of advertising websites and a different number of content network intermediary servers. Optionally, the same web server 340 can host several content websites 341.

The communication between control application 345 of web server 340 and content network intermediary servers 301, 302 and 303 can be implemented by means of any of the communication protocols used on the Internet, such as for example, the XML, XML-Schema, IP, TCP/IP, UDP, http, SOAP, RTP or RTSP protocols.

In one implementation, control application 345 communicates with various intermediary servers using a standard data format for interchanging information. In this way, control application 345 can use the same standard data format for communicating with various content network servers 301, 302 and 303, which facilitates the inclusion of new content network servers.

Therefore, for example, the various intermediary sites can use various “XML Schemas”, one for each type of message or information interchanged. An “XML Schema” is a description of an XML document type. This description is normally expressed in the form of restrictions on the structure and content of each type of document.

There are several languages developed specifically for defining “XML Schema,” including “Document Type Definition”, “RELAX NG” and “ W3C XML Schema” languages

The process of verifying whether an XML document conforms to the XML Schema is called validation. An XML document is considered to be valid only if it meets the requirements of the XML Schema with which it is associated.

In order to transmit and receive information using different XML documents defined by different XML Schemas, control application 345 can use SOAP (Simple Object Access Protocol), which is a web services protocol that uses XML and http protocols, to enable equipment communication on data networks, such as the Internet, for example.

Control application 345 interchanges information about each link with the content network intermediary servers 301, 302 and 303, enabling control application 345 to select which are the most appropriate links 3431 and 3432 for displaying on each web page 342, whenever the web page is requested by the browser of a user's device.

Web server 340 hosts a database 344 in which it stores the various information. The first information stored is the information received from content network intermediary servers 301, 302 and 303 about the various advertising links.

For each advertisement or advertising link, database 344 stores information that will be used by control application 345 to select the best advertising links, which may include some or all of the following information:
The text for the advertising link.
The image for the advertising link.
The URI from which the image of the advertising link is downloaded.
The URI to which the browser is directed when the user activates the advertising link.
A unique identifier for the advertising link.
A unique identifier indicating the category or type of product or service advertised.
A unique identifier for the intermediary server that supplied the advertising link.
A unique identifier for the advertiser.
An initial and final range of dates for the advertising campaign.
The price (CPI or “Cost Per Impression)” that the advertiser is provided to pay each time that the advertising link is displayed.
The price (CPC or “Cost Per Click)” that the advertiser is provided to pay each time that the advertising link activated on the browser of a user device.
The percentage commission (CPA or “Cost Per Action) that the advertiser is provided to pay on sales made at a virtual store as the result of a visit that is originated when the advertising link is activated.
The type of remuneration for the advertising link: CPI, CPC or CPA.
The geographic area or areas to which the advertiser wishes to restrict the advertising campaign, so that advertising links are only displayed to users within such geographic areas.
The expected CTR, or expected average number of times that the advertising link is activated for every one hundred times that it is displayed on the screen of a browser.

Database 344 may also store information about web pages 342 sent to each device 320, information about links 3431 and 3432 that are displayed on web pages 342, and information about the links activated from browser 310 of devices 320.

This information stored in the database is used by the control application 345 to select the most appropriate links for each HTTP request 311.

In the implementation of FIG. 3, database 344 is shown as part of the web server 340. However, other configurations are possible. For example, database 344 can be hosted on a different server connected to web server 340 through a data network, either a local data network or a more wide-spread data network, such as for example, a WAN (Wide Area Network). The control application 345 may also access the information of the database 344 over the Internet.

According to one implementation, the content website also has the ability to display advertisements supplied by a prior art content network, for example, the Google company's AdSense network, where it is the content network server that selects the advertising links. In such an implementation, the prior art content network server does not supply information to the control application 345.

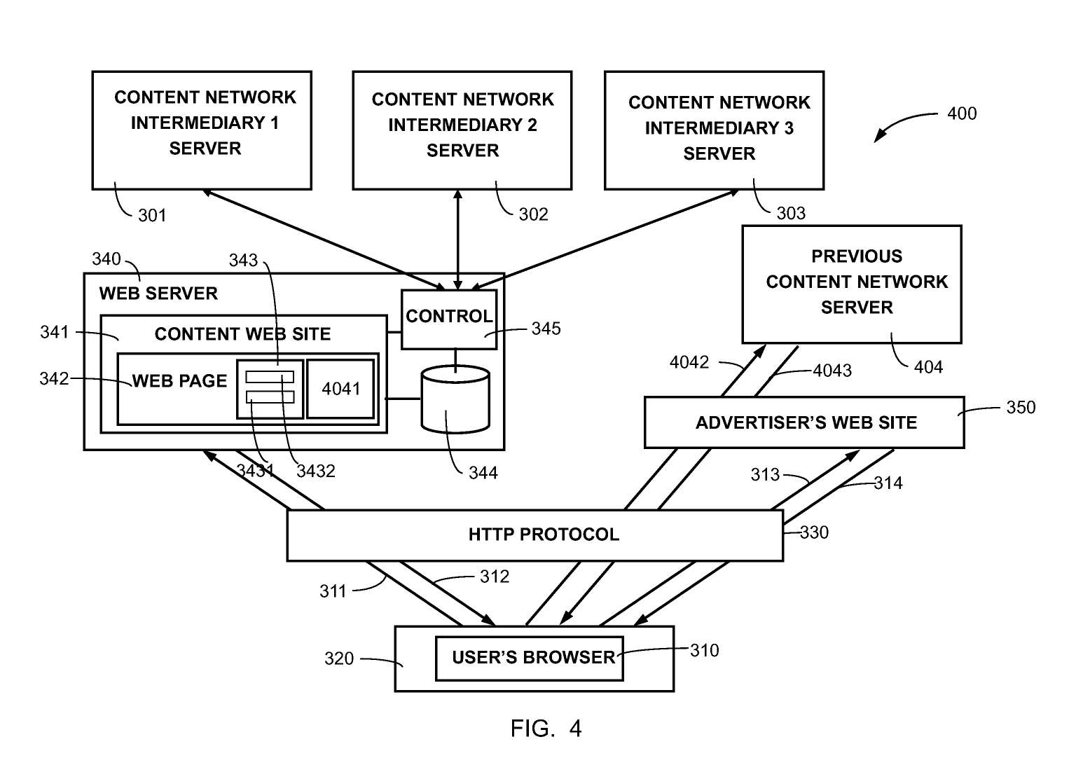

FIG. 4 shows an example of a data network 400 operating with a prior art content network server 404, “previous content network server”, which does not communicate with control application 345, but instead communicates with the browser 310 of device 320 via communications 4042 and 4043.

Hence, according to one implementation when control application 345 generates web page 342, it includes in the page code 4041 that was previously supplied by content network 404, for example a JavaScript code.

In this way, the control application 345 enables compatibility with the existing networks (e.g., Google AdSense, Facebook, etc.). Control application 345 can, by dynamically generating page 342, choose between displaying links 3431 and 3432 supplied by the intermediary servers of content networks that supply information for each link, or include JavaScript code 4041, which will enable server 404 to select the advertisements.

Optionally, control application 345 can generate a web page including both links 3431 and 3432 chosen by the web page and JavaScript code 4041.

In an implementation of FIG. 4, web page 342 is generated dynamically by control application 345 to include links 3431 and 3432 chosen by control application 345 itself, and also includes code 4041, for example using the JavaScript language, supplied by server 404 belonging to a prior state-of-the-art content network.

When this web page is downloaded by device 320 by means of messages 311 and 312, browser 310 executes the code 4041, for example using the JavaScript language, and sends an http message to server 404 by means of communication 4042 to request the links that must be displayed. Server 404 sends a reply message by means of communication 4043, and the reply message information contains links chosen by server 404 itself.

In the example of FIG. 4, control application 345 decides that web page 342 is to display both links 3431 and 3432, and the links supplied by server 404.

Alternatively, control application 345 may choose for web page 342 to display only links 3431 and 3432, or to display only the links supplied by server 404.

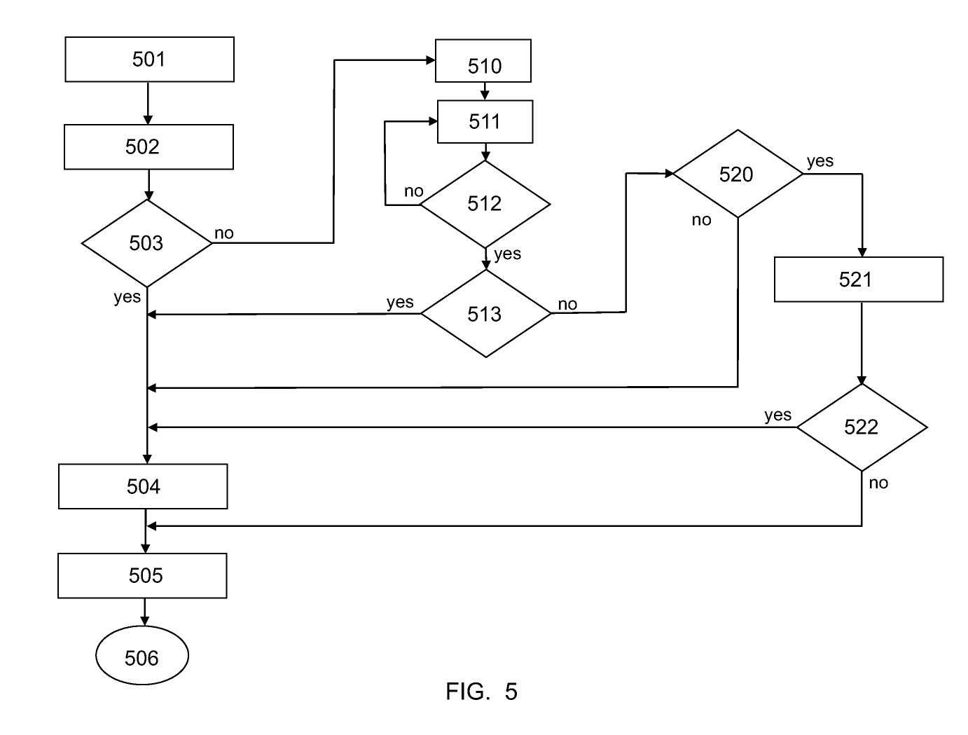

FIG. 5 is a flow chart of a process that control application 345 may adopt to select the links to display on web page 342.

The process starts at step 501, when web server 340 receives an http message from browser 310, requesting a web page, for example web page 342.

In 501, the control application determines the geographic area where device 320 is located, from which web page 342 is requested.

Internet website advertisers normally restrict publication of their advertisements to certain geographic areas, such as, for example, a certain country or a certain area within a country, since depending on the type of products or services offered, it does not make sense to publish advertisements worldwide.

In one implementation the control application 345 determines the approximate geographic area based on the originating IP address for the IP packets that transport the HTTP messages from device 320 to web server 340. In this example, database 344 has stored information that correlates groups of IP addresses with geographic areas. By use of the stored information control application 345 determines the approximate geographic area where device 320 is located from the originating IP address of the IP packets sent by device 320.

Alternatively, instead of querying database 344 regarding which geographic area a specific IP address belongs, control application 345 can obtain the information by communicating with an external server, for example, using a web service to which it sends the information about the IP address, and from which it receives information about the geographic area associated with the IP address.

Once the approximate geographic area where device 320 is located has been determined, the process described in FIG. 5 continues to the next step 503 where the control application queries database 344 with regard to the advertisements available to that geographic area, that is to say, advertisements received from the various content network intermediary servers 301, 302 and 303, from advertising campaigns that are active at the time that web page 342 is to be transmitted.

Once all the advertisements which are part of active campaigns that meet the requirement which coincide with the geographic area from database 344 have been selected from database 344, the process continues to verification 503 where it checks whether there are sufficient advertisements for displaying on page 342. If there are, it passes to 504, where it selects the best advertisements to display on the web page. If there are not, it begins a process of updating 510 by contacting the different content network intermediary servers, to query whether they have new advertisements for the determined geographic area and to update the information in database 344 for that specific geographic area where device 320, which is requesting page 342, is located.

In 510, control application 345 selects an initial content network intermediary server, for example, server 301.

In 511, control application 345 communicates with the content network intermediary server chosen in 510, requesting an updating of the advertisement information that can be displayed to users in the specific geographic area and it updates the information in database 344.

In one implementation the application verifies at 512 whether all the content network intermediary servers have previously been contacted. If they have not, it selects another content network intermediary server and again executes process 511. If they have, it goes on to verification 513.

As a result, it is not necessary for the different content network intermediary servers 301, 302 and 303 to send information about the advertisements available to control application 345 in real-time, as the application itself establishes a connection for updating advertisement data as required. This makes is possible for the different servers 301, 302 and 303 to send information about the advertisements available to application 345 in a periodic and/or programmed manner. For example, once a day or once a week.

In one implementation the process for updating the database using advertisements for a specific geographic area is not implemented each time a request for a web page from a geographic area is received for which there are insufficient advertisements in database 344, as it is not sensible, for example, to update the information every 5 seconds. The frequency with which the process beginning in step 510 is triggered, can be adjusted so that there is a timeout between two updating processes for the same geographic area. This timeout may be, for example, 30 minutes or may be adjusted in relation to the number of visitors received by web page 342 from each geographic area, updating advertisement data more frequently for geographic zones from which more visits to web page 342 are received.

In one implementation, servers 301, 302 and 303 may send information in real-time about advertisements for which control application 345 updates database 344 in real-time without the need for control application 345 to be queried. This may occur, for example, if an advertiser decides to stop a campaign and not do display certain advertisements, or if another advertiser decides to increase the price to be paid for each advertisement displayed. This reduces the risk of displaying advertisements for cancelled advertising campaigns.

In verification 513, the control application again queries database 344, using the information about updated advertisements for the specific geographic area, and verifies whether it has selected sufficient advertisements for displaying on web page 342. If it has, it passes to 504, where it will select the best advertisements. If not, it passes to verification 520.

The information used by verifications 503 and 513 to determine whether there are sufficient advertisements to display on page 342, or whether more advertisements are required, can be based on different data, such as, for example, the space occupied by each advertisement selected, the anticipated profitability of the advertisements selected, or the minimum number of advertisements. This data associated with each web page 342 can be stored, for example, in database 344.

In verification 520, control application 345 verifies whether the content website has an agreement (and therefore possesses a code to be inserted, for example using the JavaScript language) with a Google AdSense type network server 404 that selects the advertisements to be displayed on Web page 342. If not, it passes to step 504. If so, it passes to step 521, where control application 345 incorporates a code in web page 342, for example, a code using the JavaScript language supplied by server 404 itself, so that when this code is executed in browser 310, the browser displays the advertising links selected by server 404 itself on web page 342.

After step 521, the process progresses to verification 522, where the process decides whether to display in web page 342, the advertisements selected from database 344 in addition to the advertisements that will be chosen and displayed by server 404, or whether to display only the advertisements chosen by server 404. If it decides to display both the advertisements selected from database 344 and the advertisements selected by server 404, it progresses to step 504, where the best advertisements from database 344 are selected. If it decides not to, it progresses to step 505, skipping step 504, whereupon only the advertisements selected by server 404 are displayed. Decision 522 can be made by control application 345 in relation to the profitability of the advertisements selected from database 344, and the anticipated profitability of the advertisements inserted by server 404.

Although control application 345 does not receive information from server 404 about the profitability of the advertisements chosen by server 404, server 404 may periodically send statistical information, for example every month or every three months, informing content website 341 about the advertisements inserted and/or the economic compensation to which it is entitled. Based on this monthly or quarterly information, content website 341 can determine an average profitability for each advertisement displayed from server 404 and take into account the average profitability in verification 522.

In step 504, control application 345 selects the best advertising links or advertisements from database 344 for which the geographic area of the advertisement coincides with the geographic area where device 320 is located. Control application 345 can take into account different factors for selecting the best advertisements, so that revenue received from the content website is maximized. For example, it can take into account the price paid for an advertisement every time that the advertisement is displayed, the commission paid to the virtual store when a purchase is realized after activating a link on web page 342, the price paid for an advertisement every time a user activates the advertising link, the number of times an advertisement is displayed on a device that has a certain IP address, the so-called CTR percentage, which is calculated based on the number of times that users activate an advertising link or advertisement per hundred times that the advertising link or advertisement is displayed, and any other factor that may affect the profitability of the selected links. All this information associated with factors that are used for selecting the best advertising links can be stored, for example, in database 344.

Control application 345 may choose to display advertisements that have been supplied by different content network intermediary servers. For example, it can select two advertisements supplied by server 301, one advertisement supplied by server 302 and none from server 303.

Once the advertisements are selected, control application 345 inserts them into web page 342, using for example any dynamic web page generation system, such as the above-mentioned ASP (Actives Server Pages), ASP.NET or PHP or inserting the HTML code directly into web page 342. Accordingly, the selected advertising links are displayed in browser 310 of device 320 when it downloads page 342.

In step 505 web page 342 is transmitted from web server 340 to browser 310 and displayed to the user. The process ends at 506.

Once the advertising links are selected and transmitted to the user's browser, the different equipment involved exchanges messages, for example, using web services and data formats standardised by means of XML Schemas, so that the various intervening parties have information available on the advertising links displayed and can determine the corresponding economic compensations.

This also occurs when the user activates an advertising link or when a purchase is made from a virtual store. In these cases the different parties involved exchange messages containing information about the clicks produced or information about the purchases made from the virtual store.

In one implementation, when the destination advertising website is a virtual store, the virtual store provides a communication application enabling it to communicate with control application 345 and with the intermediary sites, using, for example, web services and data formats standardised by means of XML Schema. As a result, the virtual store can communicate without restriction with web server 340 and intermediary sites 301, 302 and 303, generating several advantages.

One advantage is that the virtual store paying sales commissions generated by affiliated sites can manage its advertising campaigns with different intermediary sites from the communication application itself, without the need to input data to each individual website of each of the intermediary site servers to modify or update campaigns.

Another advantage is that the virtual store can establish different types of commissions in relation to the type of category of product that it sells. Accordingly, the commission that the virtual store pays need not be a fixed percentage of the total purchase price, but rather the percentage commission may depend on each article purchased. For such purpose, the virtual store communication application transmits the commission information for each article category to the intermediary sites before the sale is made and then, once a sale generated by a visit from an affiliated website is completed, it transmits information about the article categories sold, the total sale amount for each category, as well as information about the corresponding commission.

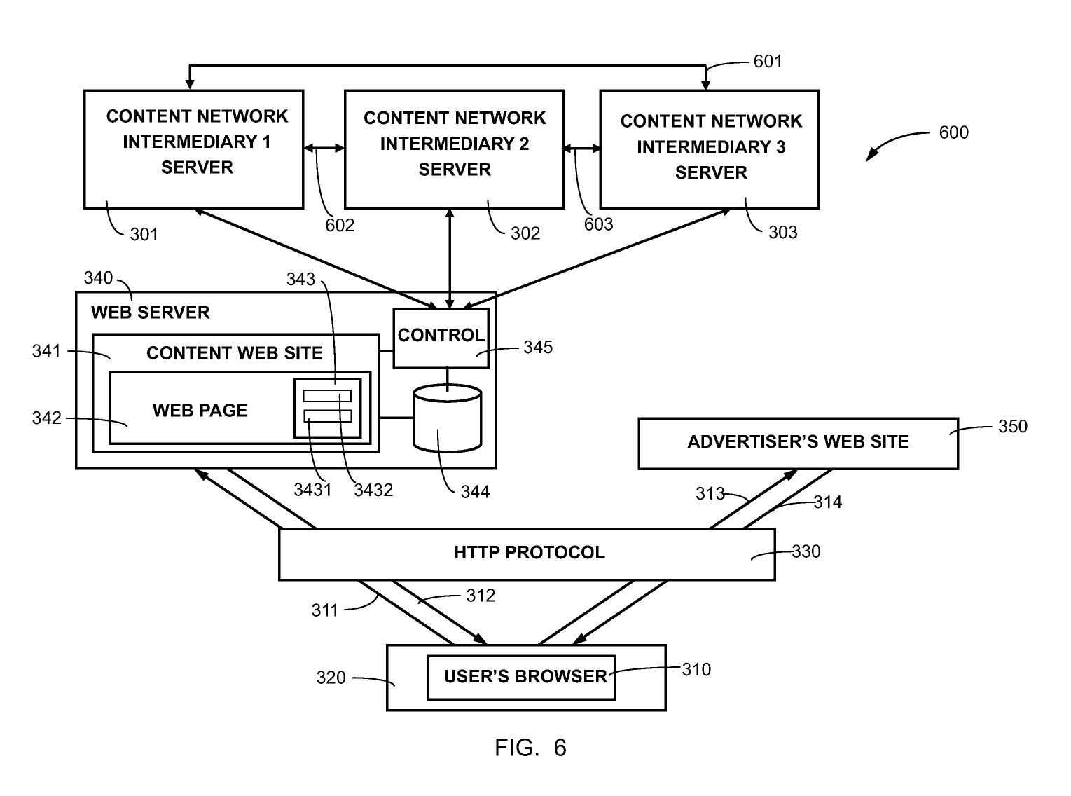

In one implementation the different content network intermediary servers have the capability to communicate with one another. FIG. 6 shows a data network 600 in which the servers communicate with each other by means of the communications indicated with lines 601, 602 and 603. In this way the different intermediaries can interchange advertising links.

What is claimed is:

1. A method for selecting one or more advertising links for incorporation into a web page of an affiliate website stored on an affiliate web server when the affiliate web server receives a request message from a browser of a computing device that requests the web page, the method comprising:
receiving in the affiliate web server via the internet and by use of a control application running on the affiliate web server the one or more advertising links and first information related to the one or more advertising links from one or more intermediary servers, the first information received from each of the one or more intermediary servers comprising target geographic data for each of the advertising links and compensation information of each of the one or more intermediary servers payable to the content website upon the one or more advertising links being activated by the computing device,
the control application storing the one or more advertising links and the first information in a database associated with the affiliate web server,
determining in the affiliate web server the geographic location of the computing device,
the control application selecting from among the one or more advertising links stored in the database one or more selected advertising links to be displayed on the web page when the web page is impressed upon the computing device, the one or more selected advertising links to be displayed on the web page being selected by a comparison of the target geographic data of the advertising links with the geographic location of the computing device and a comparison of the compensation information associated with each of the one or more advertising links,
the control application inserting the selected one or more links into the web page; and
the control application causing the web server to transmit to the browser of the computing device the web page together with the selected one or more advertising links.

2. A method according to claim 1, wherein the geographic location of the computing device is determined by identifying the originating IP address of the IP packets transporting the request message.

3. A method according to claim 1, wherein the control application determines in the affiliate web server the geographic location of the computing device by identifying the originating IP address of the IP packets transporting the request message.

4. A method according to claim 1 wherein the database resides on the affiliate web server.

5. A method according to claim 1, wherein the database is hosted on a server different from the affiliate web server.

6. A method according to claim 1, further comprising receiving in the affiliate web server via the internet a code from a content network server different than the one or more intermediary servers and transmitting from the web server to the browser of the computing device the web page containing the code along with the selected one or more links, the code comprising instructions that when executed in the computing device calls the content network server to facilitate a transmission of one or more advertising links from the content network server to the computing device for being displayed with the web page in the computing device.

7. A method according to claim 1, further comprising the control application updating the target geographic data in the database by connecting with and receiving from the one or more intermediary servers updated target geographic data and storing the updated target geographic data in the database prior to selecting from among the one or more advertising links stored in the database one or more selected advertising links to be displayed on the web page when the web page is impressed upon the computing device.

8. A method according to claim 7, wherein the control application updates the target geographic data in the database upon receiving the request message from the browser of the computing device that requests the web page.

9. A method according to claim 7, wherein the control application periodically updates the target geographic data in the database.

10. A method according to claim 1, further comprising the control application periodically updating the target geographic data in the database by connecting with and receiving from the one or more intermediary servers updated target geographic data and storing the updated target geographic data in the database.

11. A method for selecting advertising links for incorporation into a web page of an affiliate website stored on an affiliate web server when the affiliate web server receives a request message from a browser of a computing device that requests the web page, the method comprising:
receiving in the affiliate web server via the internet and by use of a control application running on the affiliate web server a first one or more advertising links and first information related to the first one or more advertising links from one or more intermediary servers, the first information received from each of the one or more intermediary servers comprising target geographic data for each of the first one or more advertising links and compensation information of each of the one or more intermediary servers payable to the content website upon the first one or more advertising links being activated by the computing device,
receiving in the affiliate web server via the internet and by use of the control application a code from a content network server different than the one or more intermediary servers, the code comprising instructions that when executed in the computing device calls the content network server to facilitate a transmission of a second one or more advertising links from the content network server to the computing device for being displayed with the web page in the computing device; and
the control application storing the first one or more advertising links and the first information in a database associated with the affiliate web server.

12. A method according to claim 11, further comprising determining the geographic location of the computing device.

13. A method according to claim 12, wherein the geographic location of the computing device is determined by identifying the originating IP address of the IP packets transporting the request message.

14. A method according to claim 11, wherein the control application determines in the affiliate web server the geographic location of the computing device by identifying the originating IP address of the IP packets transporting the request message.

15. A method according to claim 11, wherein the control application selects the web server to transmit to the browser of the computing device the web page together with the one or more of the first one or more advertising links.

16. A method according to claim 11, wherein the control application selects the web server to transmit to the browser of the computing device the web page together with code.

17. A method according to claim 11, further comprising the control application inserting the code into the webpage.

18. A method according to claim 15, further comprising determining the geographic location of the computing device.

19. A method according to claim 18, further comprising the control application selecting from among the first one or more advertising links stored in the database one or more selected advertising links to be displayed on the web page when the web page is impressed upon the computing device, the one or more selected advertising links to be displayed on the web page being selected by a comparison of the target geographic data of the advertising links with the geographic location of the computing device and a comparison of the compensation information associated with each of the one or more advertising links.

20. A method according to claim 19, further comprising the control application inserting the selected one or more links into the web page.

21. A method according to claim 20, further comprising the control application causing the web server to transmit to the browser of the computing device the web page together with the selected one or more links.

22. A method according to claim 11, wherein the database resides on the affiliate web server.

23. A method according to claim 11, wherein the database is hosted on a server different from the affiliate web server.

24. A method according to claim 19, further comprising the control application updating the target geographic data in the database by connecting with and receiving from the one or more intermediary servers updated target geographic data and storing the updated target geographic data in the database prior to selecting from among the first one or more advertising links stored in the database one or more selected advertising links to be displayed on the web page when the web page is impressed upon the computing device.

25. A method according to claim 24, wherein the control application updates the target geographic data in the database upon receiving the request message from the browser of the computing device that requests the web page.

26. A method according to claim 24, wherein the control application periodically updates the target geographic data in the database.

27. A method according to claim 11, further comprising the control application periodically updating the target geographic data in the database by connecting with and receiving from the one or more intermediary servers updated target geographic data and storing the updated target geographic data in the database.
